(19) United States
(12) Patent Application Publication
(10) Pub. No.: US 2019/0100140 A1
(43) Pub. Date: Apr. 4, 2019

(54) VEHICLE DETECTION APPARATUS

(71) Applicant: DENSO CORPORATION, Kariya-city, Aichi-pref. (JP)

(72) Inventor: Ryo TAKAKI, Kariya-city, Aichi-pref. (JP)

(21) Appl. No.: 16/086,822

(22) PCT Filed: Mar. 14, 2017
(86) PCT No.: PCT/JP2017/010285

§ 371 Date: Sep. 20, 2018

(30) Foreign Application Priority Data
Mar. 22, 2016 (JP) 2016-057504

(51) Int. Cl. B60Q 9/00; G06K 9/00; G01S 13/93; G01S 13/86; G01S 13/89

(52) U.S. Cl. CPC B60Q 9/008; G06K 9/00805; G01S 13/89; G01S 13/867; G01S 13/931

(57) ABSTRACT

An ECU detects a front vehicle which is present in a traveling direction of the own vehicle, based on an image captured by an imaging unit. The ECU includes: an end portion width calculation section which, when the front vehicle is present, calculates, as an end portion lateral width, a size of the front vehicle in a lateral direction relative to the traveling direction in a front-end or rear-end portion of the front vehicle, based on the image and dictionary information on a vehicle front or rear portion; a determination section which determines whether a side portion of the front vehicle is recognized in the traveling direction of the own vehicle; and a lateral width correction section which, if the determination section has determined that the side portion of the front vehicle is recognized, calculates a corrected lateral width by increasing the end portion lateral width.

### CROSS-REFERENCE TO RELATED APPLICATIONS

The present application claims the benefit of priority from Japanese Patent Application No. 2016-057504 filed on Mar. 22, 2016, the contents of which are incorporated herein by reference.

### TECHNICAL FIELD

The present disclosure relates to a vehicle detection apparatus which detects another vehicle which is present ahead of the vehicle.

### BACKGROUND ART

Techniques are conventionally proposed in which a camera is installed in a vehicle to detect an object (obstacle), such as an automobile or a bicycle, which is present around an own vehicle, and perform, based on a result of the detection of the object, various types of control for improving driving safety of the own vehicle, for example, activation of a brake unit, notification to a driver, and the like.

For example, the technique described in Patent Literature 1 calculates a width of a detected object in a horizontal direction from data on a captured image of an area ahead in a traveling direction, estimates a length of the detected object in a depth direction in the image, and corrects the width of the detected object in the horizontal direction based on the length in the depth direction in the image. Patent Literature 1 states that this configuration solves a problem of erroneous overestimation of a width in the horizontal direction (i.e., width in a thickness direction) of an object, for example, a guardrail or a wall, which has a great depth and curves forward, and is located ahead of the own vehicle.

### CITATION LIST

### Patent Literature

[PTL 1] JP 2010-271788 A

### SUMMARY OF THE INVENTION

When a front vehicle which is traveling ahead of the own vehicle is detected based on a camera image, previously prepared dictionary information on a vehicle rear portion is used to compare the camera image with the dictionary information by pattern matching. Then, the type, lateral width, and the like of the front vehicle are recognized based on the result of the comparison. In this case, however, when an orientation of the front vehicle is inclined with respect to the travelling direction of the own vehicle, in addition to the rear portion of the front vehicle, a side portion of the front vehicle is present on a front side of the own vehicle. Accordingly, even if the lateral width of the front vehicle in a rear end portion of the front vehicle is recognized by pattern matching, such recognition does not actually mean proper determination regarding an object with respect to which collision avoidance is to be performed by the own vehicle. In this regard, there seems to be room for improvement over the existing techniques.

Although the technique described in Patent Literature 1 provides a correction for imposing limitations on a lateral width whose actual value is less than an erroneously calculated value, the technique does not make a correction for increasing a lateral width whose actual value is more than an erroneously calculated value. Thus, the problem that the presence of the front vehicle cannot be properly detected still occurs.

The present disclosure has been made in light of the above circumstances, and has a main object of providing a vehicle detection apparatus capable of properly determining a size of a front vehicle which is present in a traveling direction of the own vehicle.

The present disclosure is a vehicle detection apparatus which detects a front vehicle which is present in a traveling direction of an own vehicle, based on an image captured by an imaging means, the vehicle detection apparatus including: an end portion width calculation section which, when the front vehicle is present, calculates, as an end portion lateral width, a size of the front vehicle in a lateral direction relative to the traveling direction of the own vehicle in a vehicle end portion on a front side or a rear side of the front vehicle, based on the image and dictionary information on a vehicle front portion or a vehicle rear portion; a determination section which determines whether a side portion of the front vehicle is recognized in the traveling direction of the own vehicle; and a lateral width correction section which, when the determination section has determined that the side portion of the front vehicle is recognized, calculates a corrected lateral width by correcting the end portion lateral width so that the end portion lateral width is increased.

A width of the front vehicle which is present in the traveling direction of the own vehicle can be calculated by using the image captured by the imaging means and referring to the dictionary information on the vehicle front portion or the vehicle rear portion. However, the front vehicle may be present in an angled state in the traveling direction of the own vehicle. Thus, in order to determine a size of the front vehicle in the lateral direction relative to the traveling direction of the own vehicle, it is preferable to take into account not only a lateral width of the front vehicle in the front-end portion or the rear-end portion of the front vehicle but also a lateral width of the front vehicle in the side portion of the front vehicle.

In this regard, according to the above configuration, it is determined whether the side portion of the front vehicle is recognized in the traveling direction of the own vehicle, and if it has been determined that the side portion of the front vehicle is recognized, the corrected lateral width is calculated by correcting the end portion lateral width so that the end portion lateral width is increased. In this case, the corrected lateral width allows proper determination of the size of the front vehicle which is present in the traveling direction of the own vehicle. This enables the own vehicle to properly perform collision avoidance control and the like with respect to the front vehicle.

### BRIEF DESCRIPTION OF THE DRAWINGS

The above object and other objects, features, and advantages of the present disclosure will be clarified by the following detailed description with reference to the accompanying drawings, wherein:

FIG. 1 is a view illustrating a schematic configuration of a PCS system;

FIG. 2 is a view illustrating an overview of a process for correcting a lateral width of a rear portion of a front vehicle so that the lateral width is increased;

FIG. 3 is a flow chart showing a procedure for correcting the lateral width of the rear portion of the front vehicle so that the lateral width is increased;

FIG. 4 is a view showing a relationship between a degree of inclination of the front vehicle and a guard value;

FIG. 5 is a flow chart showing a procedure for correcting the lateral width of the rear portion of the front vehicle so that the lateral width is increased, in another example; and

FIG. 6 is a view showing a relationship between the degree of inclination of the front vehicle and a lateral width of a side portion.

### DESCRIPTION OF THE EMBODIMENTS

The following will describe an embodiment based on the drawings. An object detection ECU according to the present embodiment is installed in an own vehicle, detects an object, such as a vehicle, which is present ahead of the own vehicle, and functions as a pre-crash safety (PCS) system which performs various types of control in order to avoid or mitigate a collision with the object.

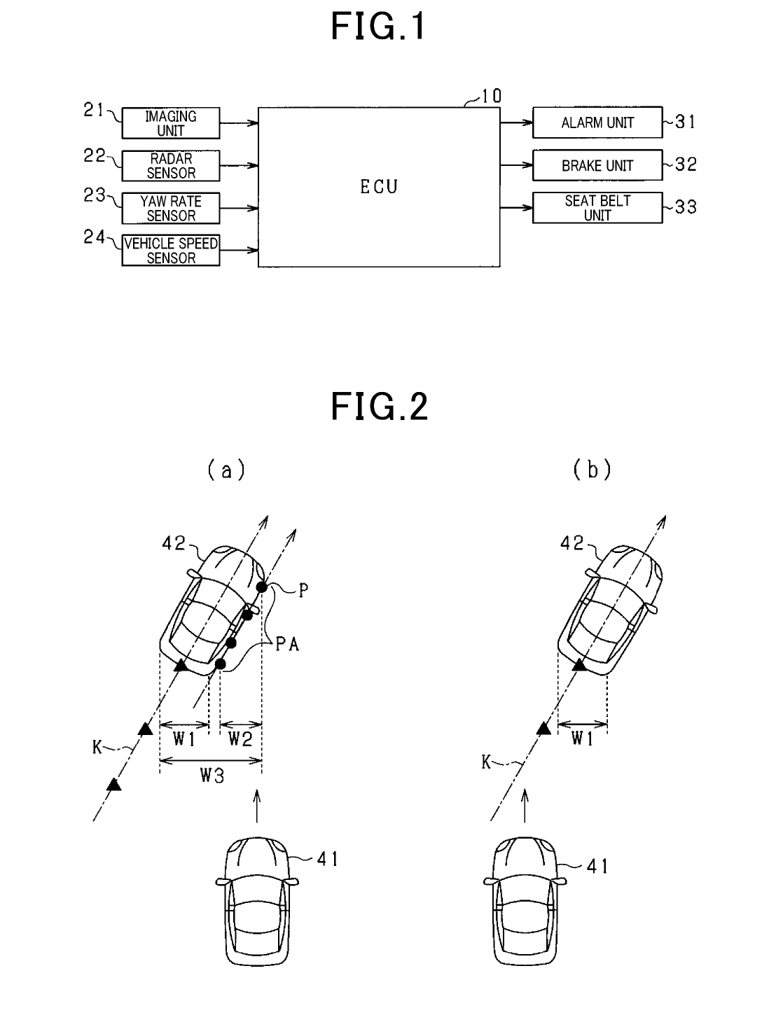

In FIG. 1, the PCS system includes an ECU 10, an imaging unit 21, a radar sensor 22, a yaw rate sensor 23, a vehicle speed sensor 24, an alarm unit 31, a brake unit 32, a seat belt unit 33, and the like.

The imaging unit 21 is configured, for example, by a CCD camera, a CMOS image sensor, a near infrared camera, or the like. In this case, the imaging unit 21 is mounted at a predetermined height in a center in a vehicle width direction of the own vehicle, and this allows the imaging unit 21 to capture, from a bird's-eye view, an image of a region extending over a predetermined angular range toward an area ahead of the own vehicle. Based on the captured image, the imaging unit 21 extracts a characteristic point indicating the presence of an object. Specifically, the imaging unit 21 extracts edge points based on information on luminance of the captured image and performs a Hough Transform with respect to the extracted edge points. In the Hough Transform, for example, a point on a straight line on which a plurality of edge points are continuously arranged or a point at which straight lines intersect with each other is extracted as the characteristic point. In a predetermined cycle, the imaging unit 21 captures an image, extracts a characteristic point, and transmits a result of the extraction of the characteristic point to the ECU 10. The imaging unit 21 may be a monocular camera or a stereo camera.

The radar sensor 22 detects an object present ahead of the own vehicle by using a directional electromagnetic wave (probe wave) such as a millimeter wave or a laser. The radar sensor 22 is mounted at a front portion of the own vehicle so that an optical axis of the radar sensor 22 is directed toward the area in front of the vehicle. The radar sensor 22 scans a region extending over a predetermined range toward the area in front of the own vehicle by using a radar signal at predetermined time intervals, and receives an electromagnetic wave reflected by a surface of a front object to acquire, as object information, information such as a distance to the front object and a relative speed with respect to the front object. The acquired object information is inputted into the ECU 10.

The yaw rate sensor 23 detects a turning angular velocity (yaw rate) of the vehicle. The vehicle speed sensor 24 detects a traveling speed of the own vehicle based on a rotational speed of a wheel. Results of the detection performed by the sensors 23 and 24 are inputted into the ECU 10.

The alarm unit 31, the brake unit 32, and the seat belt unit 33 each function as a safety unit which is driven by a control command from the ECU 10. Among these units, the alarm unit 31 is a loudspeaker or a display which is provided in a cabin of the own vehicle. When the probability of a collision with the front object has increased, the alarm unit 31 outputs an alarm sound, an alarm message, or the like to notify the driver of a collision risk.

The brake unit 32 is a braking unit which performs braking of the own vehicle. The brake unit 32 is activated when the probability of a collision with the front object has increased. Specifically, for example, the brake unit 32 increases braking force for a brake operation performed by the driver (brake assist function) or performs automatic braking (automatic brake function) when no brake operation has been performed by the driver.

The seat belt unit 33 is a pretensioner which retracts a seat belt provided in each seat of the own vehicle. When the probability of a collision with the front object has increased, the seat belt unit 33 takes preliminary action for retracting the seat belt. When the collision is inevitable, the seat belt unit 33 retracts the seat belt to remove slack and thus secures an occupant such as the driver in the seat to protect the occupant.

The ECU 10 is configured as an in-vehicle electronic control unit including a well-known microcomputer having a memory and performs PCS control by referring to a calculation program and control data in the memory. In this case, the ECU 10 detects a front object based on an image captured by the imaging unit 21, and based on a result of the detection, the ECU 10 performs collision avoidance control in which at least one of the alarm unit 31, the brake unit 32, and the seat belt unit 33 is to be controlled.

Specifically, the ECU 10 acquires image data from the imaging unit 21 and determines a type of an object which is present ahead of the own vehicle based on the image data and previously prepared dictionary information for object identification. In this case, the dictionary information for object identification is prepared, for example, for individual types of object such as automobiles, two-wheeled vehicles, and pedestrians and is previously stored in the memory. As the dictionary information for automobiles, it is preferable to prepare dictionary information on at least a front portion pattern and a rear portion pattern of the automobiles. As the front portion pattern or the rear portion pattern of the automobiles, it is preferable to prepare dictionary information, for example, for each of a plurality of vehicle types such as large vehicles, standard vehicles, and light automobiles. The two-wheeled vehicles are preferably separated into bicycles and motorcycles. The ECU 10 determines a type of the object by comparing the image data with the dictionary information by pattern matching. In addition to the dictionary information on moving objects, dictionary information on fixed objects such as guardrails, utility poles, and road signs may be included.

Based on the image data and the dictionary information, the ECU 10 calculates the size of the object (i.e., lateral width of the object) in a lateral direction relative to a traveling direction of the own vehicle. Based on the lateral width of the object, the ECU 10 performs the collision avoidance control with respect to the object. In this case, the ECU 10 calculates an overlap ratio which is a rate at which the lateral width of the object overlaps a lateral width of the own vehicle in the lateral direction orthogonal to the travelling direction of the own vehicle, and the ECU 10 performs the collision avoidance control by the safety unit based on the probability of a collision with the object according to the overlap ratio.

In a case where a front vehicle which is traveling ahead of the own vehicle is to be detected, when an orientation of the front vehicle is inclined with respect to the travelling direction of the own vehicle, in addition to a rear portion of the front vehicle, a side portion of the front vehicle is present on a front side of the own vehicle. In such a case, even when a lateral width (end portion lateral width) of the front vehicle in a rear-end portion of the front vehicle is recognized by pattern matching, the recognized size of the front vehicle with respect to which collision avoidance is to be performed by the own vehicle may be smaller than an actual size of the front vehicle.

According to the present embodiment, therefore, when a front vehicle is present, the ECU 10 determines whether a side portion of the front vehicle is recognized in the travelling direction of the own vehicle, and when the ECU 10 has determined that the side portion of the front vehicle is recognized, the ECU 10 calculates a corrected lateral width by correcting an end portion lateral width of the front vehicle so that the end portion lateral width is increased. The ECU 10 then performs the collision avoidance control and the like based on the corrected lateral width.

The following will describe, with reference to FIG. 2, an overview of a process for correcting a rear portion lateral width (end portion lateral width) of the front vehicle so that the rear portion lateral width is increased. FIG. 2 illustrates a state where an own vehicle 41 and a front vehicle 42 are present on a track and an orientation of the front vehicle 42 is inclined in a lateral direction relative to the traveling direction of the own vehicle 41. The symbol K in FIG. 2 indicates a movement path of the front vehicle 42. The movement path K is obtained, for example, based on a plurality of positions of the front vehicle which are acquired in time sequence. FIG. 2(a) illustrates a state where the front vehicle 42 is moving toward a predicted course of the own vehicle 41 in front of the own vehicle 41. FIG. 2(b) illustrates a state where the front vehicle 42 is moving away from the predicted course of the own vehicle 41.

In FIG. 2(a), a rear portion lateral width W1 is calculated based on an image of a rear portion of the front vehicle 42 captured by the imaging unit 21. Due to the position and orientation of the front vehicle 42 relative to the own vehicle 41, a side portion of the front vehicle 42 faces a front side of the own vehicle 41. That is, the side portion of the front vehicle is detectable by the radar sensor 22 installed in the own vehicle 41. When the probe wave is transmitted from the radar sensor 22 in the travelling direction of the own vehicle 41, the ECU 10 acquires a detection point P detected by using the probe wave in the front vehicle 42.

In this case, a side portion of a vehicle such as an automobile has various parts, including a side mirror and uneven areas around a door, which are possible reflection points of the probe wave, and thus a plurality of detection points P (reflection points) are acquired in a vehicle forward-backward direction. The plurality of detection points P are acquired as a point sequence PA in the side portion of the front vehicle 42, and thus a side portion lateral width W2 which is a lateral length of the front vehicle 42 in the side portion of the front vehicle 42 is calculated. Furthermore, by adding the side portion lateral width W2 to the rear portion lateral width W1, a corrected lateral width W3 (i.e., lateral width to be recognized of the front vehicle) is calculated.

Instead of the side portion lateral width W2 being a lateral distance between a leftmost detection point P and a rightmost detection point P in the point sequence PA, the side portion lateral width W2 may be a lateral distance between an end point (a right-side end point in FIG. 2) in a rear-end portion of the vehicle and a detection point P (the rightmost detection point P in FIG. 2) which is farthest from the rear-end portion.

On the other hand, in FIG. 2(b), as in FIG. 2(a), the rear portion lateral width W1 is calculated based on an image of the rear portion of the front vehicle 42 captured by the imaging unit 21. In FIG. 2(b), however, unlike in FIG. 2(a), the side portion of the front vehicle 42 does not face the front side of the own vehicle 41. That is, the side portion of the front vehicle 42 is not present on the course of the own vehicle 41. In such a case, the side portion lateral width W2 is not added to the rear portion lateral width W1, and the rear portion lateral width W1 is the lateral width to be recognized of the front vehicle.

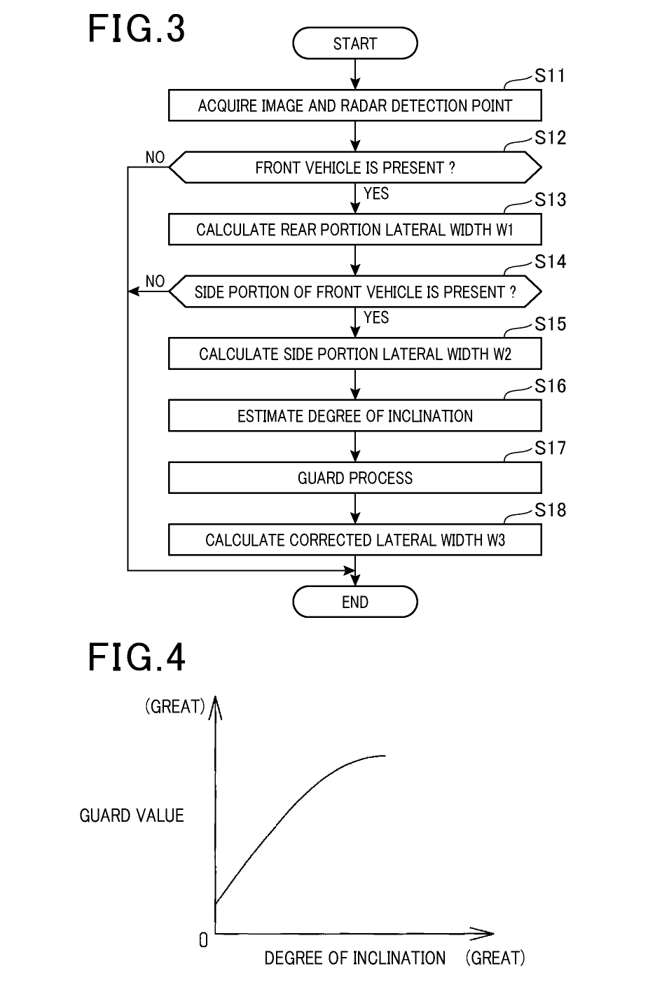

The following will describe, with reference to the flow chart in FIG. 3, a process for correcting the end portion lateral width which is performed by the ECU 10. The present process is repeatedly performed by the ECU 10 in a predetermined cycle.

First, in step S11, an image captured by the imaging unit 21 and information on a detection point detected by the radar sensor 22 are acquired. In subsequent step S12, it is determined whether the front vehicle 42 is present based on the image of the area in front of the own vehicle captured by the imaging unit 21. At this point, the determination of the presence or absence of the front vehicle 42 is made by pattern matching by referring to the dictionary information on the vehicle rear portion.

If an affirmative determination YES is made in step S12, the control proceeds to step S13, and the rear portion lateral width W1 of the front vehicle 42 is calculated based on the captured image of the front vehicle 42 and the dictionary information on the vehicle rear portion of the vehicle.

Then, in step S14, it is determined whether the side portion of the front vehicle 42 is recognized in the travelling direction of the own vehicle 41. Specifically, when the point sequence PA in which the plurality of detection points P are arranged extends in a straight line and the point sequence PA is present in front of the own vehicle 41 in its traveling direction, it is determined that the side portion of the front vehicle 42 is recognized. In this case, when the plurality of detection points P are present and the detection points P are arranged in a straight line, these detection points P are recognizable as the detection points P obtained by reflection in the vehicle side portion, and thus it is possible to determine that the side portion of the front vehicle 42 is recognized.

If a negative determination NO is made in step S14, the present process ends. In this case, the rear portion lateral width W1 is the lateral width to be recognized of the front vehicle. That is, when it has been determined that the side portion of the front vehicle 42 is not recognized, the rear portion lateral width W1 is calculated as the lateral width of the front vehicle 42.

If an affirmative determination YES is made in step S14, the control proceeds to step S15. In step S15, the side portion lateral width W2 of the front vehicle 42 is calculated based on the length of the point sequence PA in the lateral direction of the own vehicle.

Then, the ECU 10 preforms a guard process regarding the side portion lateral width W2. Specifically, in step S16, the ECU 10 estimates a degree of inclination of the front vehicle 42 with respect to the travelling direction of the own vehicle 41. At this point, the ECU 10 recognizes, for example, the movement path of the front vehicle 42 and estimates the degree of inclination based on the movement path. The degree of inclination preferably has an inclination angle which is 0° when the movement path of the front vehicle 42 extends in the same direction as (i.e., in a direction parallel to) the travelling direction of the own vehicle 41 and increases as the front vehicle 42 is directed more laterally.

In subsequent step S17, the side portion lateral width W2 is guarded with a guard value which is defined depending on the degree of inclination. In this case, the guard value is preferably set, for example, based on a relationship shown in FIG. 4. In this guard process, the side portion lateral width W2 calculated based on the point sequence PA is compared with the guard value, and the side portion lateral width W2 is guarded so that the side portion lateral width W2 does not exceed the guard value. The guard value may be set depending on a type of the front vehicle 42, that is, a type such as a light vehicle, a standard vehicle, or a large vehicle. Alternatively, the guard value may be set based on the rear portion lateral width W1.

Then, in step S18, the corrected lateral width W3 is calculated by adding the side portion lateral width W2 to the rear portion lateral width W1. That is, when it has been determined that the side portion of the front vehicle 42 is recognized, a width greater than the rear portion lateral width W1 is calculated as the lateral width of the front vehicle 42.

After the ECU 10 calculates the lateral width (W1 or W3) to be recognized of the front vehicle 42, the ECU 10 performs the collision avoidance control based on the lateral width in order to avoid or mitigate a collision with the front vehicle 42.

The present embodiment described above in detail yields the following beneficial effects.

A width of the front vehicle 42 which is traveling ahead of the own vehicle 41 can be calculated by using the image captured by the imaging unit 21 and referring to the dictionary information on the vehicle rear portion. However, the front vehicle 42 may be present in an angled state in the traveling direction of the own vehicle 41. Thus, in order to determine a size of the front vehicle 42 in the lateral direction relative to the traveling direction of the own vehicle 41, it is preferable to take into account not only the lateral width of the front vehicle 42 in the rear-end portion of the front vehicle 42 but also the lateral width of the front vehicle 42 in the side portion of the front vehicle 42.

In this regard, according to the above configuration, it is determined whether the side portion of the front vehicle 42 is recognized in the traveling direction of the own vehicle 41, and if it has been determined that the side portion of the front vehicle 42 is recognized, the corrected lateral width W3 is calculated by correcting the rear portion lateral width W1 so that the rear portion lateral width W1 is increased. In this case, the corrected lateral width W3 allows proper determination of the size of the front vehicle 42 which is present in the traveling direction of the own vehicle 41. This enables the own vehicle 41 to properly perform the collision avoidance control and the like with respect to the front vehicle 42.

Correct recognition of the front vehicle 42 inclined with respect to the traveling direction of the own vehicle 41 may be achieved by preparing dictionary information on inclined vehicles. However, the configuration of the present embodiment enables proper recognition of the width of the front vehicle 42 in an inclined orientation, without the need of the dictionary information on inclined vehicles.

According to the above configuration, when it has been determined that the side portion of the front vehicle 42 is recognized, the side portion lateral width W2 of the front vehicle 42 is calculated, and the corrected lateral width W3 is calculated by correcting the rear portion lateral width W1 using the side portion lateral width W2. That is, when the front vehicle 42 is present in an inclined state with respect to the traveling direction of the own vehicle 41, other than the rear-end portion of the front vehicle 42, the side portion of the front vehicle 42 is detectable from the own vehicle 41. In this case, although the size of the front vehicle 42 in the lateral direction relative to the traveling direction of the own vehicle 41 is presumably different depending on a direction of the own vehicle 41 and a direction of the front vehicle 42, the size of the front vehicle 42 can properly be obtained as the corrected lateral width W3.

Although assignment of the side portion of the vehicle as a pattern of dictionary information is difficult, the side portion of the vehicle has various reflection points of the probe wave in the side mirror, the uneven areas around the door, and the like. Accordingly, as described above, the side portion lateral width W2 can be calculated by acquiring the detection points (reflection points) in the side portion of the front vehicle 42. In this case, the corrected lateral width W3 (i.e., lateral width to be recognized of the front vehicle 42) can properly be calculated by using the side portion lateral width W2.

According to the above configuration, in particular, when the plurality of detection points P are acquired in the side portion of the front vehicle 42, the side portion lateral width W2 is calculated based on the length of the point sequence PA in which the plurality of detection points P are arranged. This makes it possible to properly calculate the corrected lateral width W3 while taking into account the fact that the plurality of reflection points are present in the forward-backward direction in the side portion of the front vehicle 42.

According to the above configuration, when the point sequence PA obtained based on the information detected by the radar sensor 22 extends in a straight line and the point sequence PA is present in front of the own vehicle 41 in its traveling direction, it is determined that the side portion of the front vehicle 42 is recognized. In this case, according to the form of the point sequence PA, it is possible to properly determine whether the point sequence PA corresponds to the side portion of the front vehicle 42. This improves accuracy in calculation of the corrected lateral width W3.

According to the above configuration, the degree of inclination of the front vehicle 42 with respect to the traveling direction of the own vehicle 41 is estimated, and the corrected lateral width W3 is calculated by correcting the rear portion lateral width W1 based on the estimated degree of inclination. Specifically, according to the above configuration, the corrected lateral width W3 is calculated by using the guard value which is set depending on the degree of inclination. In this case, an unnecessary increase in lateral width of the front vehicle 42 is suppressed, and thus occurrence of unnecessary action for a collision avoidance process is suppressed.

### Other Embodiments

The aforementioned embodiment may be changed, for example, as below.

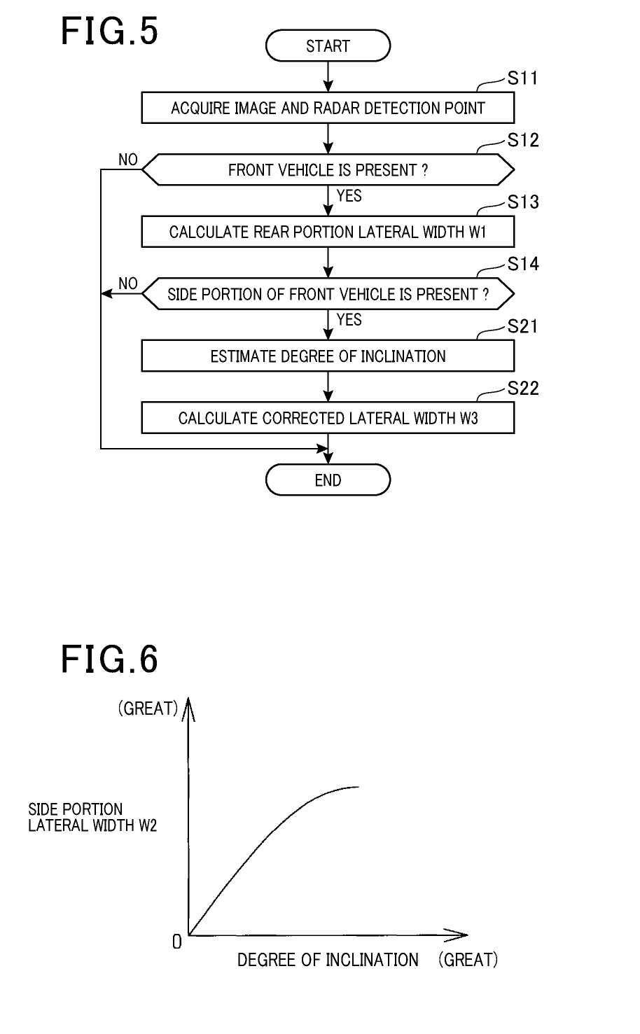

The ECU 10 may be configured such that the degree of inclination of the front vehicle 42 with respect to the traveling direction of the own vehicle 41 is estimated, and the corrected lateral width W3 is calculated by correcting the rear portion lateral width W1 based on the degree of inclination. Specifically, the ECU 10 performs a process shown in FIG. 5. This process is repeatedly performed by the ECU 10 in a predetermined cycle. Steps S11 to S14 in FIG. 5 are the same as those in FIG. 3, and thus description on these steps will be simplified.

In FIG. 5, in step S14, if it has been determined that the side portion of the front vehicle 42 is recognized, the control proceeds to step S21. In step S21, the ECU 10 estimates the degree of inclination of the front vehicle 42 with respect to the traveling direction of the own vehicle 41. At this point, the ECU 10 recognizes, for example, the movement path of the front vehicle 42 and estimates the degree of inclination based on the movement path. The degree of inclination preferably has an inclination angle which is 0° when the movement path of the front vehicle 42 extends in the same direction as (i.e., in a direction parallel to) the traveling direction of the own vehicle 41 and increases as the front vehicle 42 is directed more laterally. Alternatively, the ECU 10 may be configured such that the degree of inclination is estimated based on a direction of the point sequence PA relative to the traveling direction of the own vehicle 41.

In subsequent step S22, the corrected lateral width W3 is calculated by correcting the rear portion lateral width W1 based on the degree of inclination of the front vehicle 42. At this point, for example, by using a relationship shown in FIG. 6, the side portion lateral width W2 is calculated based on the degree of inclination, and the corrected lateral width W3 is calculated by adding the side portion lateral width W2 to the rear portion lateral width W1.

That is, when the degree of inclination of the front vehicle 42 with respect to the traveling direction of the own vehicle 41 is determined, it is possible to estimate in which direction the side portion of the front vehicle 42 extends relative to the rear portion of the front vehicle 42 and how much the side portion extends. Accordingly, the size of the front vehicle 42 can properly be obtained as the corrected lateral width W3.

The ECU 10 may be configured such that when the side portion lateral width W2 is calculated based on the length of the point sequence PA, the side portion lateral width W2 is calculated by multiplying a lateral size corresponding to the length of the point sequence PA by a predetermined increase factor. In the side portion of the vehicle, the detection points P are not necessarily acquired at positions from a frontmost-end portion to a rearmost-end portion in the forward-backward direction of the side portion, and thus the side portion lateral width W2 may be calculated as a width smaller than an actual width. By taking into account this point, the side portion lateral width W2 may be preferably calculated by increasing the lateral size corresponding to the length of the point sequence PA.

Although the above description has dealt with the ECU 10 configured such that the front vehicle 42 is detected based on the information acquired from the imaging unit 21 and the radar sensor 22, the ECU 10 may be configured such that the information acquired from the radar sensor 22 is not used. In this case, the corrected lateral width is calculated, for example, by using a predetermined correction coefficient to correct the rear portion lateral width W1 of the front vehicle 42 calculated based on the captured image and the dictionary information so that the rear portion lateral width W1 is increased. For example, different correction coefficients may be used depending on the vehicle types such as a large vehicle, a standard vehicle, and a light automobile.

The ECU 10 may be configured such that when an amount of deviation between a movement direction of the front vehicle 42 and the direction of the point sequence PA in the side portion of the front vehicle 42 has a predetermined value or less, it is determined that the side portion of the front vehicle 42 is recognized. Specifically, in step S14 in FIG. 3, the ECU 10 calculates an angle (amount of deviation) formed by the movement direction of the front vehicle 42 and the direction of the point sequence PA and determines whether the angle has the predetermined value or less. If the angle has the predetermined value or less, the ECU 10 determines that the side portion of the front vehicle 42 is recognized, and the control proceeds to subsequent step S15.

For example, when the movement direction of the front vehicle 42 is changed by steering or the like, a direction (orientation) of the front vehicle 42 is changed, and this causes deviation of the direction of the point sequence PA from the movement direction of the front vehicle 42. In such a case, the ECU 10 does not perform the process for correcting the rear portion lateral width W1 so that the rear portion lateral width W1 is increased. This configuration makes it possible to suppress erroneous correction of the rear portion lateral width W1 when the direction (orientation) of the front vehicle 42 is changed.

The ECU 10 may be configured such that when the point sequence PA in which the plurality of detection points P are arranged extends in a straight line and a difference in relative velocity with respect to the own vehicle 41 between the detection points P has a predetermined value or less, it is determined that the side portion of the front vehicle 42 is recognized. Specifically, in step S14 in FIG. 3, the ECU 10 determines whether the point sequence PA extends in a straight line and the difference in relative velocity between the detection points P has the predetermined value or less. The relative velocity of each of the detection points P is acquirable from the radar sensor 22. If an affirmative determination YES is made in step S14, the ECU 10 determines that the side portion of the front vehicle 42 is recognized, and the control proceeds to subsequent step S15.

In this case, if the difference in relative velocity between the detection points P is great, one or more of the detection points are presumably reflection points which are not present in the front vehicle 42. Accordingly, when the difference in relative velocity between the detection points P is greater than the predetermined value, it is determined that the side portion of the front vehicle 42 is not recognized, and the ECU 10 does not perform the process for correcting the rear portion lateral width W1 so that the rear portion lateral width W1 is increased. This suppresses an unnecessary increase in lateral width of the front vehicle 42.

As the determination of whether the side portion of the front vehicle 42 is recognized, a combination of at least two of the following (1) to (3) may be performed.
(1) When the point sequence PA extends in a straight line and the point sequence PA is present ahead of the own vehicle 41 in its traveling direction, it is determined that the side portion of the front vehicle 42 is recognized.
(2) When the amount of deviation between the movement direction of the front vehicle 42 and the direction of the point sequence PA has the predetermined value or less, it is determined that the side portion of the front vehicle 42 is recognized.
(3) When the point sequence PA extends in a straight line and the difference in relative velocity with respect to the own vehicle 41 between the detection points P has the predetermined value or less, it is determined that the side portion of the front vehicle 42 is recognized.

The ECU 10 may be configured such that when the front vehicle 42 is an oncoming vehicle whose traveling direction is opposite to the traveling direction of the own vehicle 41, the size of the oncoming vehicle is calculated. In this case, the ECU 10 calculates a front portion lateral width (end portion lateral width) based on the dictionary information on the front portion pattern of the front vehicle 42, and when the side portion of the front vehicle 42 is recognized, the ECU 10 calculates a corrected lateral width by correcting the front portion lateral width so that the front portion lateral width is increased.

The ECU 10 and the imaging unit 21 (in particular, a control section of the imaging unit 21) may configure a vehicle detection apparatus. Alternatively, the vehicle detection apparatus may be configured by the control section of the imaging unit 21.

The present disclosure is described based on the embodiments, but the present disclosure is considered not to be limited to the embodiments or the configurations. The present disclosure encompasses various modified examples and variations in an equivalent range. In addition, the scope and the spirit of the present disclosure encompasses various combinations or forms and other combinations or forms including only one element, one or more elements, or one or less elements of those.

1. A vehicle detection apparatus which detects a front vehicle which is present in a traveling direction of an own vehicle, based on an image captured by an imaging means, the vehicle detection apparatus comprising:
an end portion width calculation section which, when the front vehicle is present, calculates, as an end portion lateral width, a size of the front vehicle in a lateral direction relative to the traveling direction of the own vehicle in a vehicle end portion on a front side or a rear side of the front vehicle, based on the image and dictionary information on a vehicle front portion or a vehicle rear portion;
a determination section which determines whether a side portion of the front vehicle is recognized in the traveling direction of the own vehicle;
a side portion width calculation section which, if the determination section has determined that the side portion of the front vehicle is recognized, calculates, as a side portion lateral width, a size of the front vehicle in the lateral direction in the side portion of the front vehicle; and
a lateral width correction section which, when the determination section has determined that the side portion of the front vehicle is recognized, calculates a corrected lateral width by correcting the end portion lateral width so that the end portion lateral width is increased by the side portion lateral width.

2. (canceled)

3. The vehicle detection apparatus according to claim 1, further comprising an acquisition section which, when a probe wave is transmitted in the traveling direction of the own vehicle, acquires at least one detection point detected by using the probe wave in the front vehicle, wherein
the side portion width calculation section calculates the side portion lateral width based on the at least one detection point in the side portion of the front vehicle.

4. The vehicle detection apparatus according to claim 3, wherein
the at least one detection point includes a plurality of detection points, and
when the plurality of detection points are acquired on a lateral side of the vehicle end portion of the front vehicle, the side portion width calculation section calculates the side portion lateral width based on a length of a point sequence in which the plurality of detection points are arranged.

5. The vehicle detection apparatus according to claim 3, wherein when the point sequence in which the plurality of detection points are arranged extends in a straight line and the point sequence is present in front of the own vehicle in the traveling direction of the own vehicle, the determination section determines that the side portion of the front vehicle is recognized.

6. The vehicle detection apparatus according to claim 3, wherein when an amount of deviation between a movement direction of the front vehicle and a direction of the point sequence in which the plurality of detection points are arranged has a predetermined value or less, the determination section determines that the side portion of the front vehicle is recognized.

7. The vehicle detection apparatus according to claim 3, wherein when the point sequence in which the plurality of detection points are arranged extends in a straight line and a difference in relative velocity with respect to the own vehicle between the detection points has a predetermined value or less, the determination section determines that the side portion of the front vehicle is recognized.

8. The vehicle detection apparatus according to claim 1, further comprising an inclination estimation section which estimates a degree of inclination of the front vehicle with respect to the traveling direction of the own vehicle, wherein
the lateral width correction section calculates the corrected lateral width by correcting the end portion lateral width based on the degree of inclination.

9. A vehicle detection apparatus which detects a front vehicle which is present in a traveling direction of an own vehicle, based on an image captured by an imaging means, the vehicle detection apparatus comprising:
an end portion width calculation section which, when the front vehicle is present, calculates, as an end portion lateral width, a size of the front vehicle in a lateral direction relative to the traveling direction of the own vehicle in a vehicle end portion on a front side or a rear side of the front vehicle, based on the image and dictionary information on a vehicle front portion or a vehicle rear portion; and
a determination section which determines whether a side portion of the front vehicle is recognized in the traveling direction of the own vehicle, wherein
if the determination section has determined that the side portion of the front vehicle is not recognized, the end portion width calculation section calculates the end portion lateral width as a lateral width of the front vehicle, and if the determination section has determined that the side portion of the front vehicle is recognized, the end portion width calculation section calculates a width greater than the end portion lateral width as the lateral width of the front vehicle.

10. A vehicle detection apparatus which detects a front vehicle which is present in a traveling direction of an own vehicle, based on an image captured by an imaging means, the vehicle detection apparatus comprising:
an end portion width calculation section which, when the front vehicle is present, calculates, as an end portion lateral width, a size of the front vehicle in a lateral direction relative to the traveling direction of the own vehicle in a vehicle end portion on a front side or a rear side of the front vehicle, based on the image and dictionary information on a vehicle front portion or a vehicle rear portion;
a determination section which determines whether a side portion of the front vehicle is recognized in the traveling direction of the own vehicle;
an inclination estimation section which estimates a degree of inclination of the front vehicle with respect to the traveling direction of the own vehicle; and
a lateral width correction section which, when the determination section has determined that the side portion of the front vehicle is recognized, calculates a corrected lateral width by correcting the end portion lateral width based on the degree of inclination so that the end portion lateral width is increased.
